(19) United States
(12) Patent Application Publication
(10) Pub. No.: US 2009/0152436 A1
(43) Pub. Date: Jun. 18, 2009

(54) PROJECTOR AND SUPPORTING STRUCTURE THEREOF

(75) Inventor: Shan-Qin Bao, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/233,597

(22) Filed: Sep. 19, 2008

(30) Foreign Application Priority Data
Dec. 14, 2007 (CN) 200710203079.8

(51) Int. Cl. F16M 11/00

(52) U.S. Cl. 248/637

(57) ABSTRACT

A projector includes a main body emitting light beams from a front end to form an image, a supporting member for supporting the main body, the supporting member is pivotally mounted to a side wall of the main body, so that the main body may tilt with respect to the supporting member to obtain an adjusted position to project the image, and a fastening member fastening the supporting member on the side wall at the adjusted position. A supporting structure thereof is also provided.

### BACKGROUND

1. Field of the Invention

The present invention generally relates to projectors, and more particularly, to a projector having a supporting structure capable of adjusting a projection angle of the projector.

2. Description of Related Art

Projectors have been widely used for conference room presentations, classroom trainings, home theater applications, and so on. It is a common occurrence that the projector's image may be misaligned with the screen, that is, the projector may be inclined too high or too low when an image is being projected on a screen. Therefore, adjustable legs are disposed at the bottom of the projector for adjusting a projection angle of the projector. To adjust the projector's angle, the projector must be turned over, and the legs adjusted, by shortening or extending the lengths of the legs, after which the projector is again returned to its original position, and the projection angle is observed, if the projection angle is aligned, no further adjustment is needed, if the projection angle is not aligned, the process is repeated as needed.

However, in the adjustment procedure with the above-mentioned structure, the users may spend a lot of time to adjust the projection angle of the projector. Therefore, an improved projector that can be aligned easily is needed.

### SUMMARY

A projector includes a main body emitting light beams from a front end to form an image, a supporting member for supporting the main body, the supporting member is pivotally mounted to a side wall of the main body, so that the main body may tilt with respect to the supporting member to obtain an adjusted position to project the image, and a fastening member fastening the supporting member on the side wall at the adjusted position. A supporting structure thereof is also provided.

Other systems, methods, features, and advantages of the present projector and supporting structure thereof will be or become apparent to one with skill in the art upon examination of the following drawings and detailed description. It is intended that all such additional systems, methods, features, and advantages be included within this description, be within the scope of the present apparatus, and be protected by the accompanying claims.

### BRIEF DESCRIPTION OF THE DRAWINGS

Many aspects of the present projector and supporting structure of the projector can be better understood with reference to the following drawings. The components in the drawings are not necessarily to scale, emphasis instead being placed upon clearly illustrating the principles of the present device. Moreover, in the drawings, like reference numerals designate corresponding components throughout the several views.

FIG. 1 is an isometric view of a projector with two supporting structures being collected in accordance with an exemplary embodiment;

FIG. 2 is an exploded isometric view of the projector including the supporting structures; and

FIG. 3 is an isometric view of the projector after the supporting structures have been adjusted.

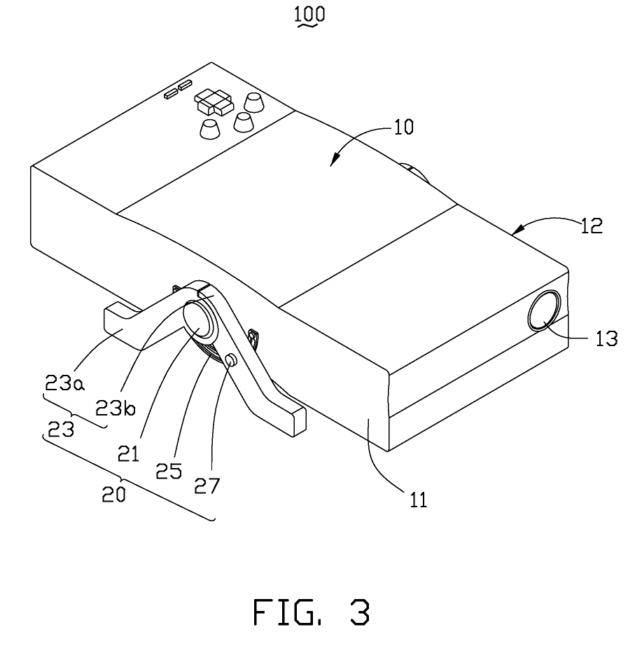

### DETAILED DESCRIPTION

Reference will now be made to the drawings to describe the preferred embodiments of the present projector and the supporting structure thereof, in detail.

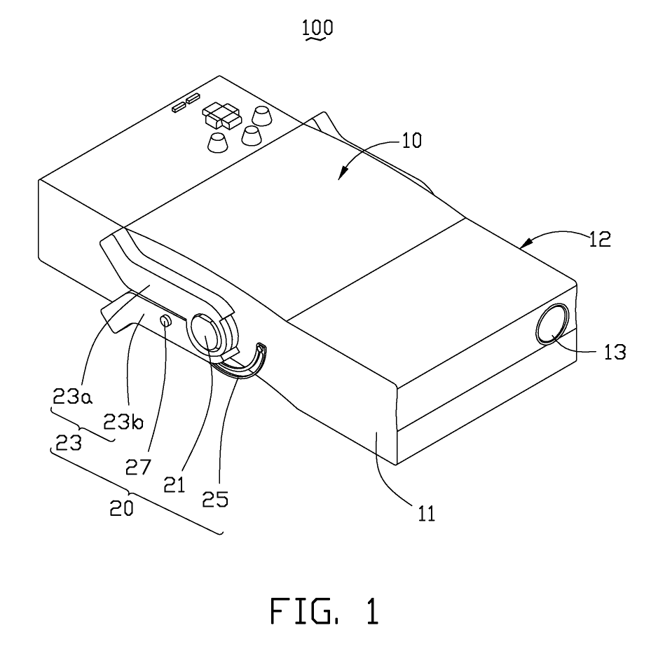

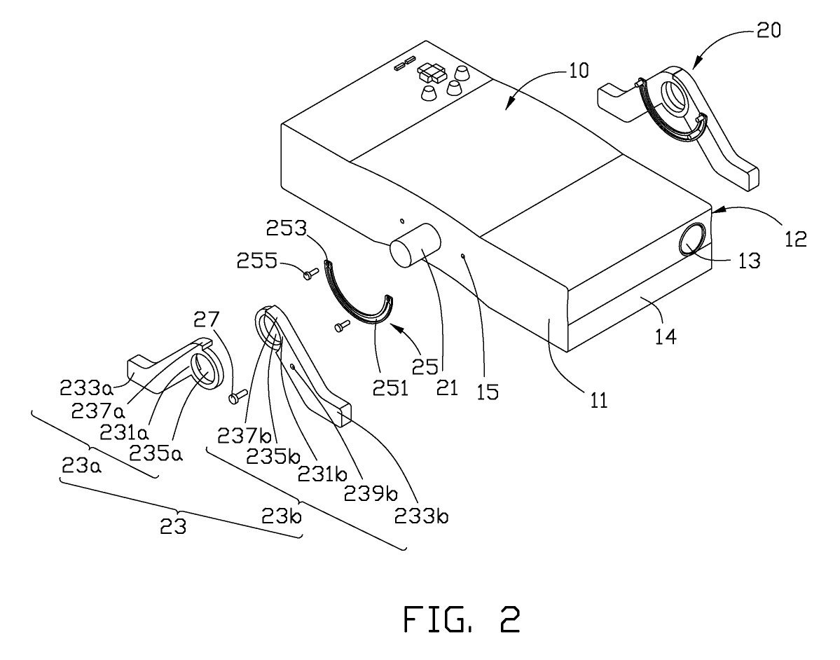

Referring to FIGS. 1 and 2, a projector 100 in accordance with an exemplary embodiment includes a main body 10 and two supporting structures 20 for supporting the main body 10. The two supporting structures 20 are disposed at opposite sides of the main body 10. The supporting structures 20 can be adjusted so that the projector 100 projects an image on a screen (not shown) at an optimized projection angle.

The main body 10 may be a rectangular parallelepiped. A lens module 13 is disposed on a front end 14 of the main body 10 to emit light so as to reproduce an image on a screen. Opposite side surfaces 11, 12 of the main body 10 define two threaded holes 15.

The two supporting structures 20 are disposed on the two side surfaces 11, 12. Because the two supporting structures 20 have similar structures and functions, only one of the supporting structures 20 disposed on the side surface 11 will be described hereinafter. The supporting structure 20 includes a pivot shaft 21, a supporting member 23, a guide rail member 25, and a fastening member 27. The pivot shaft 21 and the guide rail member 25 are disposed on the main body 10. The supporting member 23 is pivotally rotatable around the pivot shaft 21 and is capable of adjusting and supporting the main body 10. The fastening member 27 is used for fixing the supporting member 23 at different positions relative to the guide rail member 25.

In the exemplary embodiment, the two pivot shafts 21 are molded integrally with the main body 10. The pivot shafts 21 protrude from the middle of the side surfaces 11, 12 of the main body 10 between the two threaded holes 15. In other embodiments, the pivot shafts 21 can be two single separate units, and are fixed on one of the main body 10 and the supporting member 23, and rotatablely attached to the other one.

The guide rail member 25 defines an arc guide groove 251, and two fastening holes 253 at opposite ends. The guide rail member 25 is fastened on a bottom portion of the side surface 11 by screwing two screws passing the two fastening holes 253 and engaged in the threaded hole 15 of the side surface 11. In other embodiments, the guide rail member 25 can be molded integrally with the main body 10.

The supporting member 23 includes a first leg 23a and a second leg 23b for supporting the projector 100 on a table (not shown). The first leg 23a includes a rotatable end 231a and a supporting end 233a. The second leg 23b includes a rotatable end 231b and a supporting end 233b. The rotatable ends 231a, 231b is pivotally rotatable around the pivot shaft 21. The supporting ends 233a, 233b are configured for contacting the table.

The rotatable end 231a defines a pivot hole 235a for allowing the pivot shaft 21 to pass through. A stopping portion 237a protrudes from the rotatable end 231a next to the two pivot hole 235a. The rotatable end 231b defines a pivot hole 235b for allowing the pivot shaft 21 to pass. A stopping portion 237b protrudes from the rotatable end 231b near the pivot hole 235b. A fastening hole 239b is defined in the rotatable end 231b and next to the supporting end 233b. The pivot holes 235a, 235b are used for allowing the pivot shaft 21 to pass through so as to pivotally attach the first leg 23a and the second leg 23b to the side surface 11 of the main body 10.

The fastening member 27 is configured for passing through the fastening hole 239b and screwed into the guide groove 251 to fix the second leg 23b.

FIG. 1 shows that the first leg 23a and the second leg 23b are put together on the side surface 11 of the main body 10. The method of adjusting the projection angle of the projector 1 00 by the supporting members 23 on the side surface 11, 12 will be described below. Firstly, the first leg 23a and the second leg 23b are rotated around the pivot shaft 21 until the first leg 23a and the second leg 23b stop rotating, because the stopping portion 237a of the first leg 23a and the stopping portion 237b of the second leg 23b meet each other and prevent further rotation. Thus, the main body 10 is supported on the table (not shown) by the first leg 23a and the second leg 23b. Secondly, a front end 14 of the main body 10 where the lens 13 is located can be raised or lowered, by tilting (pressing or lifting) the main body 10 with respect to the supporting members 23, to adjust the projection angle of the projector. After the projection angle is correctly aligned, the front end 14 of the main body 10 no longer needs to be raised or lowered. Finally, the fastening member 27 passes through the fastening hole 239 and is screwed into the guide groove 251 to fix the second leg 23b, at the adjusted position, to the main body 10. Alternatively, the fastening member 27 may be loosely attached/screwed in the guide groove 251 whereby the main body 10 can be freely tilted with respect to the supporting member 23. Thus, after the projection angle is correctly aligned the fastened member 27 is tightened to keep the projection angle in place.

Because the supporting structure 20 includes the first leg 23a and the second leg 23b that are pivotally rotatable around the pivot shaft 21 protruding from the side wall 11, 12 of the main body 10, the projector 100 need not be turned over to adjust the projection angle. Instead, only the front end 14 of the main body 10 needs to be lifted and/or pressed to adjust the projection angle and screwing the fastening member 27 through the fastening hole 239 and into the guide groove 251 to hold the main body 10 to the supporting member 23 to maintain the projection angle. Therefore, it is convenient for the users to adjust the second leg 23b.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the componenticular use contemplated. Alternative embodiments will become apparent to those skilled in the art to which the present invention pertains without decomponenting from its spirit and scope. Accordingly, the scope of the present invention is defined by the appended claims rather than the foregoing description and the exemplary embodiments described therein.

What is claimed is:

1. A projector comprising:
a main body for emitting light beams to form an image;
a supporting member for supporting the main body, the supporting member is pivotally mounted to a side wall of the main body, so that the main body may tilt with respect to the supporting member to obtain an adjusted position for projecting the image; and
a fastening member fastening the supporting member on the side wall at the adjusted position.

2. The projector as claimed in claim 1, further comprising a pivot shaft, wherein the pivot shaft protrudes from the side wall of the main body, and the supporting member is rotatably attached to the pivot shaft.

3. The projector as claimed in claim 2, wherein the pivot shaft is disposed at the middle of the side wall of the main body.

4. The projector as claimed in claim 2, wherein the supporting member comprises two legs resisting each other and rotatable mounted to the side wall.

5. The projector as claimed in claim 4, wherein the two legs respectively comprise a rotatable end defining pivot holes for the pivot shaft to pass through and a supporting end for supporting the main body.

6. The projector as claimed in claim 5, wherein two stopping portions resisting each other to stop the two legs rotating are respectively disposed on the rotatable end.

7. The projector as claimed in claim 6, wherein the stopping portions are protrusions respectively protruding from the rotatable ends.

8. The projector as claimed in claim 1, further comprising a guide rail member fixed on the side wall of the main body, the leg is fixed on the guide rail member by the fastening member.

9. The projector as claimed in claim 8, wherein an arced groove is defined in the guide rail member, the leg is fastened at different positions of the groove by the fastening member.

10. The projector as claimed in claim 4, wherein the two legs respectively comprise a rotatable end pivoting on the side wall of the main body and a supporting end for supporting the main body on a table.

11. The projector as claimed in claim 10, wherein two stopping portions resisting each other to stop the two legs rotating are respectively disposed on the rotatable end.

12. The projector as claimed in claim 11, wherein the stopping portions are protrusions respectively protruding from the rotatable ends.

13. The projector as claimed in claim 1, wherein the supporting member are two supporting member structure disposed at two opposite side walls of the main body.

14. A supporting structure for supporting a device, wherein the supporting structure comprising:
a supporting member for supporting the device, the supporting member is rotatably mounted on a side wall of the device; so that the device may tilt with respect to the supporting member to obtain an adjusted position; and
a fastening member fastening the supporting member on the side wall at the adjusted position.

15. The supporting structure as claimed in claim 14, further comprising a guide rail member, an arced groove is defined in the guide rail member, the leg is fastened at different positions of the groove by the fastening member.

16. The supporting structure as claimed in claim 14, wherein the supporting member comprises two legs resisting each other and rotatable mounted to the side wall.

17. The supporting structure as claimed in claim 16, wherein the two legs respectively comprise a rotatable end pivotable on the side wall of the device and a supporting end for supporting the device.

18. The supporting structure as claimed in claim 17, wherein two stopping portions resisting each other to stop the two legs rotating are respectively disposed on the rotatable end.

19. The supporting structure as claimed in claim 18, wherein the stopping portions are protrusions respectively protruding from the rotatable ends.
